(19) United States
(12) Patent Application Publication
(10) Pub. No.: US 2015/0245600 A1
(43) Pub. Date: Sep. 3, 2015

(54) Fishing Sinker

(71) Applicant: Jack Brighenti, Bradenton, FL (US)

(72) Inventor: Jack Brighenti, Bradenton, FL (US)

(21) Appl. No.: 14/630,872

(22) Filed: Feb. 25, 2015

Related U.S. Application Data
(60) Provisional application No. 61/946,378, filed on Feb. 28, 2014.

(51) Int. Cl. A01K 95/00

(52) U.S. Cl. CPC A01K 95/005

(57) ABSTRACT

This invention relates to the process of creating a fishing line sinker using a recycled firearm ammunition shell casing. The firearm ammunition shell casing is obtained after the bullet has been fired from it. The shell casing then undergoes a process to make it capable of serving as a fishing sinker. The shell casing is made out of non-toxic brass, steel or any other rigid metal, making it a safe, non-toxic alternative as a fishing sinker. The recycled ammunition shell sinker provides an environmentally friendly means of adding weight to the casting line. Fishermen will appreciate the sinker's cylindrical design which allows for ease of attachment, unimpeded casting, fewer line tangles, and little chance of snags. The polished brass of the recycled shell casing additionally serves to attract fish and increase the fishermen's chance of landing a successful catch. The entire process of creating the sinker does not involve the use of any new materials. This low cost means of creating a non toxic sinker will allow it to replace the inexpensive but dangerous lead sinkers on the market today.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates generally to fishing devices. More particularly, the present invention relates to a process of creating fishing sinkers.

2. Description of Related Art

Weight is traditionally added to a casting line to increase the distance that a fisherman can achieve and to guide the fishing lure to an appropriate position in the water. This weight is commonly known as a sinker. Sinkers may be composed of any dense material, such as lead or bismuth. Sinkers can be attached to the line in a variety of ways, including tying the sinker to the baited end using a separate leader or attaching it directly to the main line either by threading it through a loop in the sinker and tying it off or by compressing a split shot to the line.

Numerous patents involving fishing sinkers have been issued throughout the years. Most traditional sinkers are created out of lead due to its density and wide availability. These sinkers often become detached from the line during casting or snag on underwater obstacles. In recent years, the safety of lead in the environment has been highly questioned. Lead is toxic to fish and birds, and is also toxic to humans. Many states have actually banned the use of lead sinkers for these reasons.

Some patents have addressed the need for non-toxic fishing weights. For instance, U.S. Pat. No. 5,243,779 A provides for a snag-less fishing sinker having a non-toxic biodegradable woven case encompassing non-toxic metal balls. U.S. Pat. No. 8,261,484 B2 describes a detachable sinker with a disintegrating water soluble material. While these sinkers are non-toxic, they suffer from several drawbacks. They are complex, involving the use of multiple materials and sometimes even hand crafting to achieve the weight. They lack an aerodynamic build and could impact a fishermen's casting ability. Further, they require the production of new materials and material costs render them incapable of replacing traditional lead sinkers.

### SUMMARY OF THE INVENTION

The general purpose of the present invention is to provide a means of creating fishing sinkers out of recycled firearm ammunition shell casings, otherwise known as bullet cartridges. The process of creating the sinker begins with the firing of the weapon, which releases a spent shell casing. The shell casing, which would otherwise be discarded, is then obtained and provided a new use as a fishing sinker after our processing of it. The shell casing is generally made of non-toxic brass, but can be made from steel or another rigid metal or combination of metals, making it a far safer alternative than traditional lead sinkers.

The use of these recycled shell casings creates an environmentally friendly way to add weight to the fishing line. The recycled firearm shell casing makes an ideal fishing sinker as it is cylindrical in shape and fastens easily to the line. This low cost means of creating a non toxic sinker will allow it to replace the inexpensive but dangerous lead sinkers on the market today.

To process the firearm shell casing for use of a fishing sinker, the firing pin is first removed from the ammunition shell casing, allowing the easy passage of the line through the weight. The firing pin is removed using a depriming tool which deprimes or decaps cartridges. The depriming tool uses different fittings to accommodate the depriming of any size cartridge. After depriming, the shell casing is sent through a tumbler to clean and shine it. Course media is deposited into the tumbler to refine and shine the brass. The casing is additionally shined with brass polish. In this preferred embodiment, the hollow, deprimed recycled shell casing is then threaded twice through the fishing line, thus becoming the ideal, environmentally friendly fishing sinker.

The various calibers of bullets, and hence varying sizes of cartridges, make for a variety of sinker weights. Larger caliber casings can be used for deep sea fishing or other deep water fishing, while lighter caliber casings can be used for in shore fishing, including rivers and streams.

While the process of obtaining the fired ammunition shell casing and cleaning it through the tumbler remains constant, different variations can be made to the casing itself to make it an ideal fishing weight. In another embodiment, rather than using the hollow, deprimed casing, the recycled ammunition shell casing is filled with a mixture of non-toxic materials such as concrete, adding weight to the sinker. A hole wide enough to allow passage of the fishing line is then drilled through the entirety of the shell casing. Just as in the initial preferred embodiment, the fishing line is then looped twice through the sinker to secure it.

In another embodiment, the firearm ammunition casing is split using a metal cutter, allowing it to be fastened to the line like a traditional split shot sinker. Alternatively, the casing itself remains intact but a piece of metal, rubber, or other substance is passed through the top of the empty shell casing, through the hollow interior, and out of the bottom of the shell casing, in which the firing pin has been removed. The piece of metal can then be clamped to the line as a traditional split shot sinker, allowing ease of attachment of the sinker and doing away with the need to re-tie the line.

The recycled shell casings can be readily packaged and sold for use of fishing sinkers. The low cost of creating these sinkers, which comprise no new materials, will allow them to be a viable alternative to dangerous lead sinkers, which many states have banned the use of.

The cylindrical design of the fishing sinker creates ease of casting for the fishermen. It is aerodynamic and does not have the common problem of impeding casting. Further, the sinker does not tangle the line. It is fastened securely above the lure or bait. Given its cylindrical design, its chance of becoming entangled on underwater obstacles is minimal.

Firearm cases, when polished after firing, have the additional benefit of being shiny. Fish are attached to shiny objects, and will be drawn to the shiny casing.

This process of creating a fishing sinker from a firearm ammunition shell casing provides a simple, environmentally friendly means of adding weight to one's line. The fishing sinker is entirely composed of recycled materials that will not harm fish or wildlife. Firearm ammunition casings come in a wide variety of weights and sizes, allowing them to be made into fishing sinkers that will accommodate any fishing condition, including off shore fishing.

Whereas the wide adoption of other non-toxic sinkers has been hindered by price, the described fishing sinker's use of entirely recycled materials allows it to replace inexpensive but dangerous traditional lead sinkers.

### BRIEF DESCRIPTION OF THE DRAWINGS

FIG. 1 is a front elevational view of a fishing sinker showing my novel design, wherein the fishing sinker resembles a firearm ammunition shell casing;

FIG. 2 is an axonometric frontal perspective with ¼ cut removed to highlight interior thereof.

FIG. 3 is a right side elevational view of the sinker described in FIG. 1;

FIG. 4 is a left side elevational view thereof;

FIG. 5 is a top perspective transparent view of the sinker described in FIG. 1;

FIG. 6 is a top perspective transparent view with ¼ cut removed thereof;

FIG. 7 is a close up top view of the sinker described in FIG. 1;

FIG. 8 is a close up bottom view of the sinker described in FIG. 1;

FIG. 9 is an axonometric bottom perspective of the sinker described in FIG. 1;

FIG. 10 is an axonometric bottom perspective with ¼ cut removed to highlight interior thereof;

FIG. 11 is an axonometric frontal perspective thereof;

FIG. 12 is an axonometric frontal perspective with ¼ cut removed to highlight interior of the sinker described in FIG. 1;

FIG. 13 is a front perspective view of the sinker as described in FIG. 1;

FIG. 14 is a transparent view of the sinker with ¼ cut removed to illustrate the fishing line being threaded through the sinker;

FIG. 15 is a transparent view of the sinker with ¼ cut removed to illustrate the double looping of the fishing line to secure the sinker.

### DETAILED DESCRIPTION

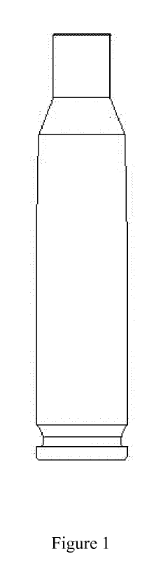

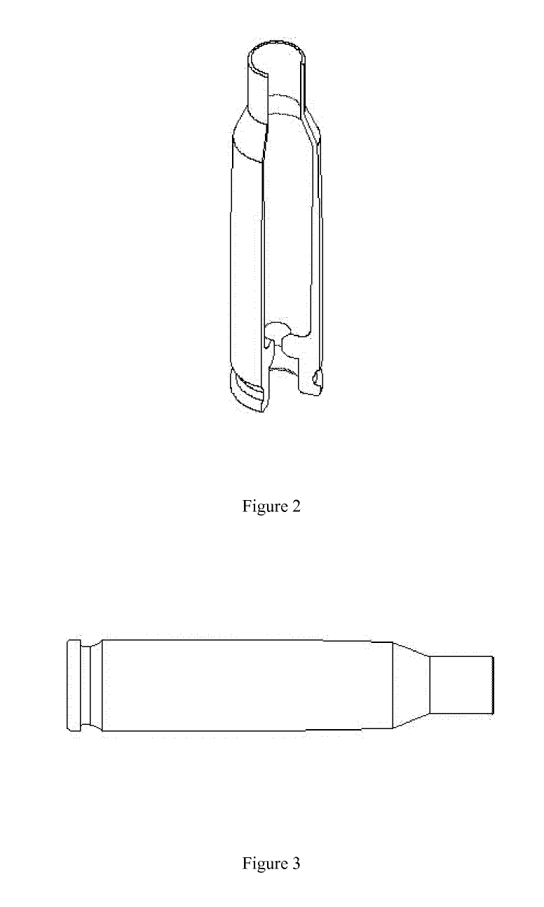

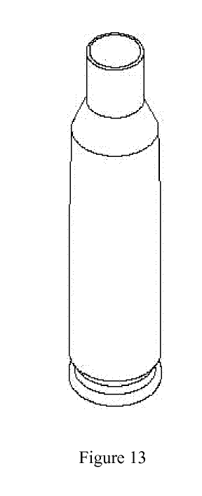

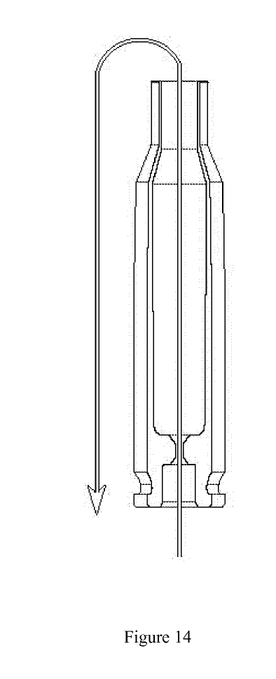

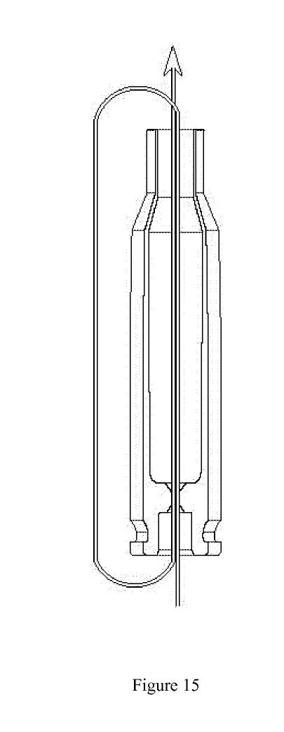

Referring now to the invention in more detail, in FIG. 1 there is shown a fishing sinker created from a firearm ammunition shell casing. The shell casing is obtained after the bullet it once held has been fired. This empty casing, which would otherwise be discarded, is provided a new purpose as a fishing sinker. FIG. 13 provides another perspective of the sinker, illustrating its cylindrical shape, with the top narrowing around the neck area. The bottom contains an elliptical groove. In its preferred embodiment, the sinker is hollow as depicted in FIG. 2. The firing pin of the recycled ammunition shell casing is removed using a depriming tool, as shown in FIG. 8. The top of the sinker contains an empty circle, as depicted in FIG. 7. These elements combine to create an empty, hollow space in which the fishing line can pass through the sinker. FIG. 14 shows the line being threaded through the sinker. FIG. 15 then shows the fishing line being re-looped through the hollow sinker, allowing it to be fastened securely to the line. The entire process, as evidenced in the drawings, provides a simple means of creating a fishing sinker from a discarded piece of non-toxic metal.

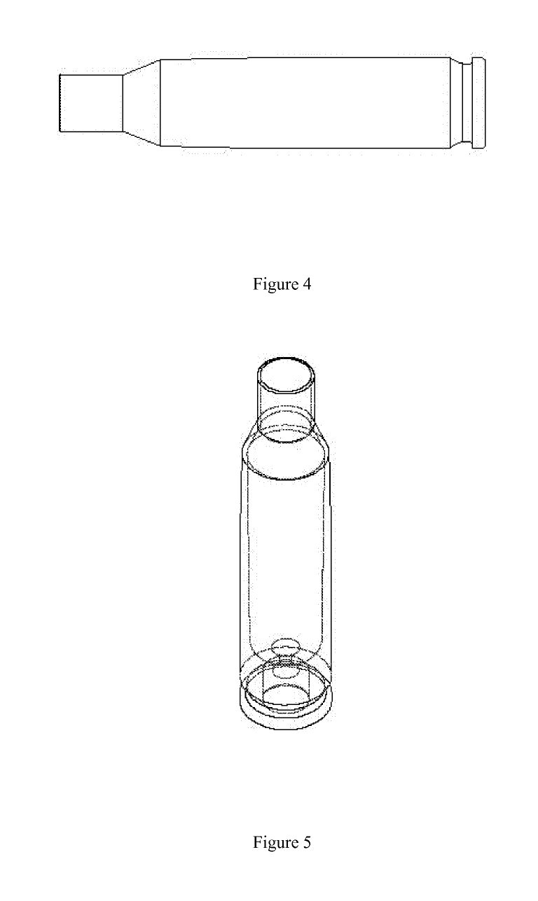

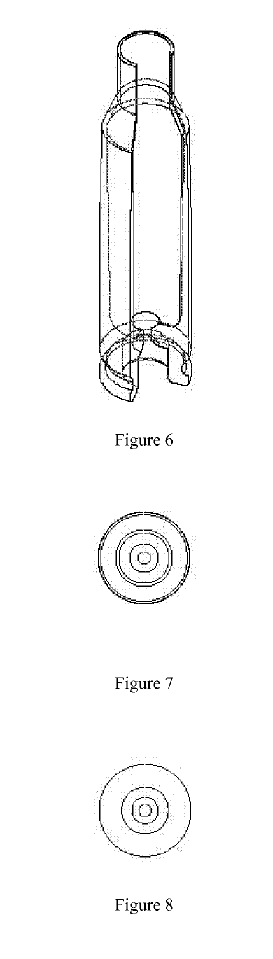

The sinker is of aerometric design, as depicted in FIGS. 3 and 4. It is threaded onto the line, becoming a seamless part of it. The sinker's cylindrical shape, as evidenced in FIG. 1 prevents snagging or dragging of the line.

In another embodiment, the once hollow recycled firearm shell casing is filled with a non-toxic material, such as concrete. A transparent view of the sinker as provided in FIG. 5 illustrates the area that would be filled. A hole running from the top of the sinker, as in FIG. 7, through to the bottom, FIG. 8, would be drilled through the hardened metal compound. The fishing line would then be threaded as described in FIGS. 14 and 15.

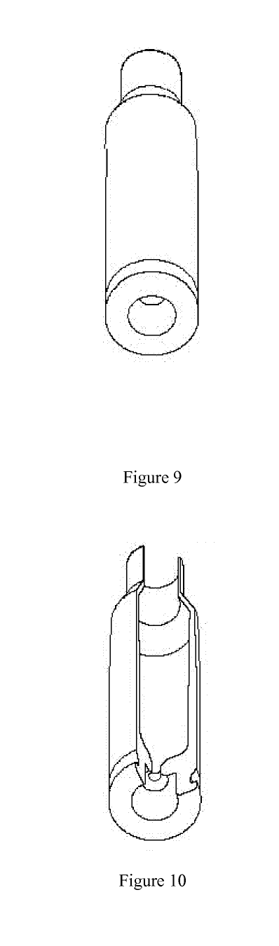

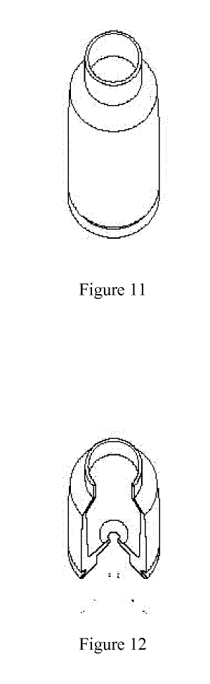

Turning back to a detailed examination of the sinker's design, FIG. 9 shows the rounded lip at the bottom of the sinker. The empty inside of the sinker from this bottom perspective is depicted in FIG. 10. Looking down on the sinker, as in FIG. 11, we see its narrow neck opening to a cylindrical middle. As before, with a cut from the drawing removed in FIG. 12, we see the hollow interior that allows for ease of attachment to the fishing line.

In another embodiment, the recycled ammunition casing is actually split, as in FIG. 2. The recycled shell casing is split using any sort of metal cutter. The sinker is then capable of attaching to the line as a split shot sinker. The line is placed in the groove between the split sides of the firearm casing, and the casing is pinched onto the line. This method allows for easy on/off of the sinker and eliminates the need to continuously retie the fishing or leader line.

In yet another embodiment, a piece of metal, rubber, or any other material is inserted through the top of the empty shell casing, as depicted in FIG. 11, though the hollow interior, and out through the bottom of the bullet in which the firing pin or primer has been removed, as in FIG. 8. The metal then forms a surface upon which the fishing line can be clamped or otherwise secured, allowing for ease of attachment.

In all embodiments, the sinker is created by a process of obtaining a recycled firearm ammunition casing which consists of brass, steel, or another rigid metal or combination of metals, and altering the casing so that it can function as a fishing sinker. The firing pin of the casing is generally removed, as in FIG. 8 and the casing is polished in a tumbler to provide an additional attractant to fish.

1. A method of creating a fishing sinker from a recycled firearm ammunition shell casing or bullet case or cartridge.

2. The method described in claim 1, whereby the method comprises:
obtaining a spent shell casing, wherein the bullet has already been expelled from the shell casing
fastening said recycled shell casing onto a fishing line as a fishing sinker

3. The method described in claim 1, whereby the method comprises:
obtaining a spent shell casing, wherein the bullet has already been expelled from the shell casing
packaging the recycled shell casing for sale and use as a fishing sinker

4. The method described in claim 1, whereby the method comprises:
obtaining a spent shell casing, wherein the bullet has already been expelled from the shell casing
removing the primer or firing pin from the recycled shell casing using a depriming tool
cleaning and polishing the shell casing
placing the shell casing onto the fishing line to serve as a fishing sinker

5. The method described in claim 1, whereby the method comprises:
obtaining a spent shell casing, wherein the bullet has already been expelled from the shell casing
removing the primer or firing pin from the recycled shell casing using a depriming tool
cleaning and polishing the shell casing
inserting a piece of metal, rubber, or any other material, through the entire shell casing
attaching the shell casing to the fishing line using the piece of material that has been inserted through the casing

6. The method described in claim 1, whereby the method comprises:
obtaining a spent shell casing, wherein the bullet has already been expelled from the shell casing
cleaning and polishing the shell casing
filling the shell casing with a non-toxic material
boring a hole through the material within the casing
inserting the fishing line through the hole to attach the casing as a sinker

7. The method described in claim 1, whereby the method comprises:
obtaining a spent shell casing, wherein the bullet has already been expelled from the shell casing
cleaning and polishing the shell casing
cutting the shell casing along one side
pinching the casing to the fishing line as a split shot sinker

8. A fishing line sinker comprising a recycled firearm ammunition shell casing or cartridge.

9. The fishing line sinker as in claim 8, wherein said shell casing is made of a rigid metal material.

10. The fishing sinker as in claim 9, wherein said shell casing is made of brass.

11. The fishing sinker as in claim 8, wherein the shell casing is empty or hollow.

12. The fishing sinker as in claim 11, wherein the firing pin is removed from the shell casing.

13. The fishing sinker in claim 8, wherein the shell casing is filled with a mixture of non-toxic materials, including cement.

14. The fishing sinker in claim 13, wherein a hole is then placed through the filled shell casing.

15. The fishing sinker in claim 8, wherein the recycled shell casing is split on one side.

16. The fishing sinker in claim 15, wherein the split fishing sinker is hollow.

17. The fishing sinker in claim 15, wherein the split fishing sinker is filled with a non-toxic material, such as cement.

18. The fishing sinker in claim 8, wherein a piece of metal, rubber, or any other substance is threaded through the top of the shell casing, through the empty interior, and through the bottom of the bullet in which the firing pin has been removed.

19. The fishing sinker in claim 18, wherein the inserted piece of metal, rubber, or any other substance protrudes from the bottom of the ammunition shell casing, forming a surface upon which the fishing line can be secured.
